(19) United States
(12) Patent Application Publication
(10) Pub. No.: US 2024/0047768 A1
(43) Pub. Date: Feb. 8, 2024

(54) CONTROL METHOD OF VEHICLE POWER SOURCE AND STORAGE MEDIUM

(71) Applicant: DENSO CORPORATION, Kariya-city (JP)

(72) Inventors: Toshiro ISHIHARA, Kariya-city (JP); Keisuke IKUSHIMA, Kariya-city (JP)

(21) Appl. No.: 18/485,428

(22) Filed: Oct. 12, 2023

Related U.S. Application Data
(63) Continuation of application No. PCT/JP2022/014475, filed on Mar. 25, 2022.

(30) Foreign Application Priority Data
Apr. 23, 2021 (JP) 2021-073379

(51) Int. Cl. H01M 10/42; B60R 16/033; H01M 10/48; H01M 10/44

(52) U.S. Cl. CPC H01M 10/425; B60R 16/033; H01M 10/48; H01M 10/44; H01M 2220/20; H01M 2010/4278

(57) ABSTRACT

A control method of vehicle power source includes: acquiring a predetermined power amount measured by a power amount measurement unit of the vehicle; monitoring a decrease in battery remaining power amount based on the predetermined power amount in response to turning off of a main switch of the vehicle; calculating a standby period based on a decreasing tendency of the battery remaining power amount; continuing a power supply state from a power source unit of the vehicle to a wireless communication unit of the vehicle in response to turning off of the main switch; and terminating the power supply state in response to elapse of the standby period.

### CROSS REFERENCE TO RELATED APPLICATIONS

The present application is a continuation application of International Patent Application No. PCT/JP2022/014475 filed on Mar. 25, 2022, which designated the U.S. and claims the benefit of priority from Japanese Patent Application No. 2021-073379 filed on Apr. 23, 2021. The entire disclosures of all of the above applications are incorporated herein by reference.

### TECHNICAL FIELD

The present disclosure relates to a control method of vehicle power source and a storage medium storing control program of vehicle power source.

### BACKGROUND

In recent years, with the development of connected cars and the sophistication of vehicles such as mobility as a service (MaaS), not only on-board communication devices but also a large number of ECUs such as an ECU that performs advanced safety control communicate with a center located outside the vehicle to provide various kinds of services. Accordingly, various demands are expected to be satisfied.

### SUMMARY

The present disclosure provides a control method of vehicle power source. The control method includes: acquiring a predetermined power amount measured by a power amount measurement unit of the vehicle; monitoring a decrease in battery remaining power amount based on the predetermined power amount in response to turning off of a main switch of the vehicle; calculating a standby period based on a decreasing tendency of the battery remaining power amount; continuing a power supply state from a power source unit of the vehicle to a wireless communication unit of the vehicle in response to turning off of the main switch; and terminating the power supply state in response to elapse of the standby period.

### BRIEF DESCRIPTION OF DRAWINGS

Objects, features and advantages of the present disclosure will become apparent from the following detailed description made with reference to the accompanying drawings. In the drawings:

FIG. 1 is a diagram illustrating functional blocks according to a first embodiment;

FIG. 2 is a diagram illustrating a change in remaining battery power amount over time;

FIG. 3 is a flowchart showing an operation executed by a control unit;

FIG. 4 is a diagram illustrating functional blocks according to a second embodiment;

FIG. 5 is a diagram illustrating a change in remaining battery power amount over time;

FIG. 6 is a flowchart showing an operation executed by a control unit;

FIG. 7 is a diagram illustrating functional blocks according to a third embodiment;

FIG. 8 is a diagram illustrating a change in remaining battery power amount over time; and

FIG. 9 is a diagram illustrating functional blocks according to a fourth embodiment.

### DETAILED DESCRIPTION

Before describing embodiments of the present disclosure, related arts will be described first.

Regarding vehicle related communication services, there is a demand for performing a communication service using data communication even during a parked state at home or the like. There is a demand that a smartphone expects to acquire information about various states of an odometer and information about recorded data of a drive recorder from the vehicle. There is a demand for data communication related to control of charging, air conditioning, or the like. There is a demand for activating a communication application of a vehicle in the parked state, downloading data from a cloud server, and updating a software in the parked state. There is a demand for uploading transmission data such as data related to vehicle traveling to a cloud server.

In order to provide a communication service, an on-board communication device and an on-board device in which an application is installed need to operate together. Since power consumption is required for the communication service, electric power of a battery for starting an engine in a case of an engine vehicle or electric power of a battery for driving in a case of an electric vehicle is required to be consumed in the parked state. For this reason, the electric power may become insufficient at the time of the next traveling and the vehicle cannot travel in the worst case for lack of the battery power.

For example, when a user turns off an ignition switch of a vehicle and parks the vehicle, power supply of a vehicle battery to an on-board communication device is continued for a predetermined standby period in response to the turning off of the ignition switch. During this standby period, it is possible to provide a communication service in which the user remotely checks a state of the vehicle, remotely operates the on-board device, or notifies the user of position information for tracking purpose when the vehicle is stolen.

When the standby period is set as described above, the battery may be excessively consumed when the standby period is long. Thus, it has been proposed to set a standby period of a certain duration after the ignition switch is turned off, and to extend the standby period in response to a specific event, such as vehicle theft as a trigger. In another example, a standby state and a non-standby state are switched in accordance with a time schedule.

However, the above-described techniques basically wait for a certain period after the ignition switch is turned off. Thus, in a case where the remaining battery power amount is small, waiting for the certain standby period may cause excessive consumption of battery power. Further, in a case where there is a sufficient margin in the remaining battery power amount, it is impossible to wait for a period longer than the preliminarily set certain period. That is, it is difficult to calculate an appropriate standby period according to the remaining battery power amount.

According to an aspect of the present disclosure, by executing processes using a computer, the method: acquires a predetermined power amount measured by a power amount measurement unit; monitors a decrease in battery remaining power amount based on a predetermined power amount in response to turning off of a main switch of the vehicle; calculates a standby period for which a power supply state to a wireless communication unit is continued based on a decreasing tendency of the battery remaining power amount; continue the power supply state from a power source unit to a wireless communication unit in response to turning off of the main switch; and terminate the power supply state in response to elapse of the standby period. With this configuration, the standby period can be properly set in accordance with remaining battery power amount when the main switch of vehicle is turned off.

The following will describe embodiments of the present disclosure with reference to the accompanying drawings. In the following embodiments, functionally or structurally corresponding parts are assigned with the same reference symbols.

### First Embodiment

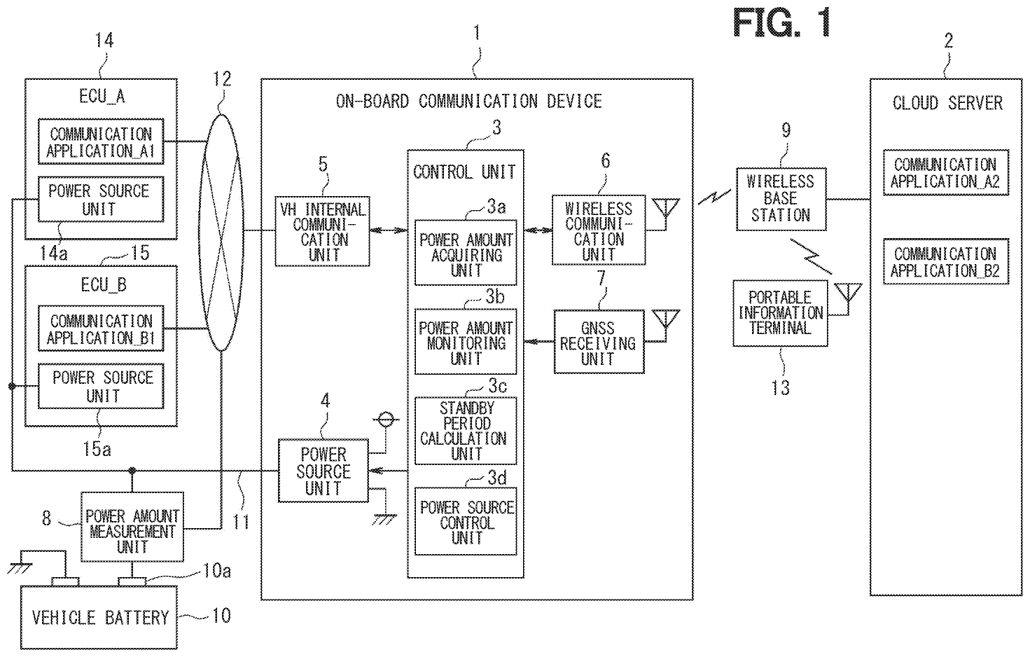

The first embodiment will be described with reference to FIG. 1 to FIG. 3.

A vehicular communication system includes an on-board communication device 1 mounted on a vehicle and a cloud server 2 provided in an external center. The on-board communication device 1 includes a control unit 3, a power source unit 4, a vehicle internal communication unit 5, a wireless communication unit 6, a global navigation satellite system (GNSS) receiving unit 7, and a power amount measurement unit 8.

The control unit 3 is provided by a microcomputer having a central processing unit (CPU), a read only memory (ROM), a random access memory (RAM), and an input/output (I/O). The control unit 3 controls an overall operation of the on-board communication device 1 by executing a computer program stored in a non-transitory tangible storage medium.

The wireless communication unit 6 performs wide area wireless communication between a wireless base station 9 and the cloud server 2 connected via a wide area communication network (not shown).

The GNSS receiving unit 7 extracts various parameters from a GNSS signal received from a communication satellite, calculates a current position using the extracted various parameters, and outputs position information indicating the calculated current position to the control unit 3.

The power amount measurement unit 8 is provided on a power source terminal 10a of a vehicle battery 10. The power amount measurement unit 8 measures power consumption amount of the vehicle battery 10, and transmits the measured power consumption amount to the on-board communication device 1 via an in-vehicle LAN 12. The power consumption amount is an example of a predetermined power amount.

The vehicle battery 10 is connected to a power supply line 11 via the power amount measurement unit 8, and power is constantly supplied from the vehicle battery 10 to the power source unit 4 via the power supply line 11. The power source unit 4 supplies electric power of the vehicle battery 10 to each unit constituting the on-board communication device 1 in a stabilized state. The power source unit 4 can execute a power save mode in which current consumption is suppressed in response to an instruction from the control unit 3. In the power save mode, power supply to the wireless communication unit 6 and the GNSS receiving unit 7 is stopped while power supply to other power supply targets is continued. The current consumption of each of the wireless communication unit 6 and the GNSS receiving unit 7 is relatively larger than that of each of other power supply targets.

The vehicle is equipped with multiple electronic control units ECU_A14 and ECU_B15. Each ECU 14, 15 executes data communication with the on-board communication device 1 via the in-vehicle LAN12. In the present embodiment, it is assumed that two ECUs 14 and 15 are mounted on the vehicle. Actually, a large number of ECUs are mounted on the vehicle.

The ECU 14 is equipped with a communication application_A1 and includes a power source unit 14a. The ECU 15 is equipped with a communication application_A2, and includes a power source unit 15a. The power source units 14a and 15a are supplied with power from the vehicle battery 10 via the power supply line 11. As will be described later, the communication application_A1 and the communication application_A2 are applications in respective ECUs communicate with the communication application_A1 and the communication application_A2 installed in the cloud server 2 via the wireless communication unit 6, respectively.

The control unit 3 includes a power amount acquiring unit 3a, a power amount monitoring unit 3b, a standby period calculation unit 3c, and a power source control unit 3d. These units may be implemented by a computer program. The power amount acquiring unit 3a acquires, from the power amount measurement unit 8, the power consumption amount of the vehicle battery 10. The power amount monitoring unit 3b monitors a decrease in the power consumption amount. The standby period calculation unit 3c calculates the standby period as will be described later based on the decreasing tendency of the power consumption amount monitored by the power amount monitoring unit 3b. The power amount acquiring unit 3a is an example of the power amount acquiring unit.

The power source control unit 3d instructs the power source unit 4 to perform the power save mode in response to the input of the OFF signal from the main switch. When the power save mode is instructed, the power source unit 4 stops power supply to the wireless communication unit 6 and the GNSS receiving unit 7. The main switch is an ignition switch in an engine vehicle or a start switch in an electric vehicle or a hybrid vehicle. In the present embodiment, an ignition switch will be described as an example. The OFF signal from the ignition switch is indicated by an OFF level of an ACC signal or an IG signal. Hereinafter, ON of the ignition switch is referred to as IG-ON, and OFF of the ignition switch is referred to as IG-OFF.

In the IG-ON state, the control unit 3 and the wireless communication unit 6 execute an on-board communication service. Examples of the on-board communication service include a communication service such as an emergency call, a destination setting by data communication, and a voice call. In the IG-OFF state, parked state communication service is executed. Examples of the parked state communication service include communication services such as theft tracking, remote engine start, and remote door lock and unlock.

Examples of the parked state communication service include a communication service executed immediately after parking at an IG-OFF time and a periodic communication service executed during parked state at each arrival time of a specific date and time, which is set in advance.

For example, the communication service executed immediately after parking may include a communication service in which a door lock forgetting notification signal indicating forgetting to lock a door is transmitted from a door lock ECU to the cloud server 2 via the wireless communication unit 6. When the cloud server 2 receives the door lock forgetting notification signal from the on-board communication device 1, the cloud server 2 transmits the door lock forgetting notification signal to a portable information terminal 13 of the user set in advance as a transmission destination. Upon receiving the door lock forgetting notification signal from the cloud server 2, the portable information terminal 13 notifies the user of forgetting of door lock. The portable information terminal 13 may be a mobile phone, a smartphone, a tablet, or the like.

When the user locks the door in response to the notification from the portable information terminal 13, the portable information terminal 13 receives the door lock operation and transmits a door lock instruction signal to the cloud server 2. When receiving the door lock instruction signal from the portable information terminal 13, the cloud server 2 transmits the door lock instruction signal to the on-board communication device 1. When the control unit 3 receives the door lock instruction signal from the cloud server 2 via the wireless communication unit 6, the control unit 3 outputs the door lock instruction signal from the vehicle internal communication unit 5 to the door lock ECU to perform door lock control.

For example, the periodic communication service executed during parked state may include a communication service in which a current position notification signal indicating a parking position which is a current position calculated by the GNSS receiving unit 7 is transmitted from the wireless communication unit 6 to the cloud server 2. When receiving the current position notification signal from the on-board communication device 1, the cloud server 2 transmits the current position notification signal to the portable information terminal 13 set in advance as a transmission destination.

The cloud server 2 determines a possibility of vehicle theft by using the history of the current position, and transmits a theft notification signal to the portable information terminal 13 when it is determined that there is a possibility of vehicle theft. The portable information terminal 13 notifies the user of the vehicle's current position when receiving the current position notification signal from the cloud server 2, and notifies the user of the possibility of vehicle theft when receiving the theft notification signal.

The operation as described above is executed by, for example, the communication application_A1 installed in the ECU_A 14 and the communication application_A2 installed in the cloud server 2 operating in cooperation with one another.

In order to implement the periodic communication service during parked state as described above, it is necessary to continue power supply from the vehicle battery 10 to the entire vehicle such as the ECUs 14 and 15 in addition to the on-board communication device 1 even after ignition is turned off, that is, IG-OFF. In this case, when the power supply state from the vehicle battery 10 is continued for a long period of time, the remaining battery power amount decreases. As a result, it is difficult to start the engine in an engine vehicle or a hybrid vehicle, and it is difficult to travel with a sufficient remaining travel power in an electric vehicle.

The control unit 3 calculates a standby period that ensures a start of engine in the case of an engine vehicle or a hybrid vehicle and ensures sufficient remaining traveling power in the case of an electric vehicle. The control unit 3 instructs the power source unit 4 to perform the power save mode when the standby period ends. Accordingly, it is possible to suppress an excessive decrease in the power consumption of the vehicle battery 10.

In a case where the standby period is set to a certain period, the battery remaining power amount at the end of the standby period may be insufficient or excessive for the next traveling. Thus, the standby period may not be properly set. In view of such circumstances, the present embodiment enables a proper setting of standby period based on the remaining battery power amount.

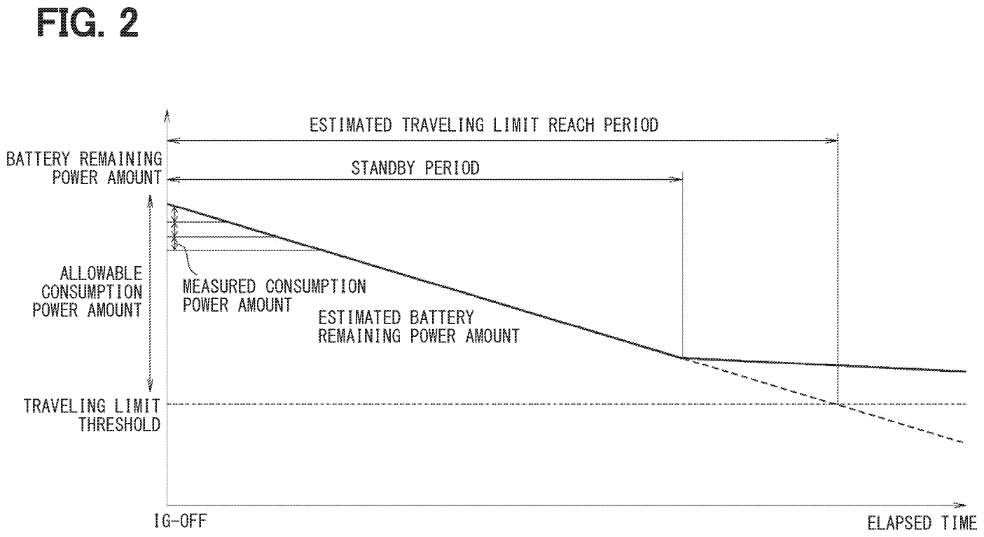

As shown in FIG. 2, a traveling limit threshold indicates a limit electric power required to drive a cell motor in the case of an engine vehicle or a hybrid vehicle, and indicates a limit electric power that can provide sufficient traveling power in the case of an electric vehicle. The traveling limit threshold is also referred to as a start limit threshold. When the remaining battery power amount decreases to the traveling limit threshold, start of the vehicle may be difficult or sufficient remaining traveling power cannot be ensured. Therefore, by accurately detecting the decreasing tendency of the remaining battery power amount, the standby period, which ensures start of vehicle or sufficient remaining electric power for traveling purpose, can be properly calculated.

Thus, the power amount measurement unit 8 is provided to the power source terminal 10a of the vehicle battery 10, and the battery power consumption amount of the vehicle battery is acquired by the power amount measurement unit 8. Then, the standby period is calculated based on the battery power consumption amount.

The power consumption amount per unit time in the entire vehicle can be regarded as constant when ignition is turned off, that is, IG-OFF. Thus, the battery remaining power amount can be regarded as linearly decreasing with elapse of time.

In a case where the user turns off the ignition IG-OFF, a standby period calculation process is executed for calculating a standby period on the basis of a decreasing tendency of the remaining battery power amount from the execution time of IG-OFF. A period until a straight line indicating the decreasing tendency intersects with the traveling limit threshold, that is, a traveling limit reach period until the remaining battery power amount decreases to the traveling limit threshold is estimated. Then, the standby period in which a sufficient margin is set with respect to the estimated start limit reach period is calculated.

As shown in FIG. 2, during the standby period, power is supplied to the wireless communication unit 6 and the GNSS receiving unit 7, each of which has a relatively large current consumption. Thus, the amount of decrease in the remaining battery power amount per unit time is large. On the other hand, when the standby period ends, the power supply to the wireless communication unit 6 and the GNSS receiving unit 7 is stopped and the power supply to other power supply targets is continued. Thus, the amount of decrease in the remaining battery power amount per unit time is decreased.

The following will describe an operation of the control unit 3. It is assumed that the on-board communication device 1 is in the power save mode in response to the previous IG-OFF. Thus, the power supply from the power source unit 4 to the wireless communication unit 6 and the GNSS receiving unit 7 is stopped, and the power supply to other power supply targets is continued.

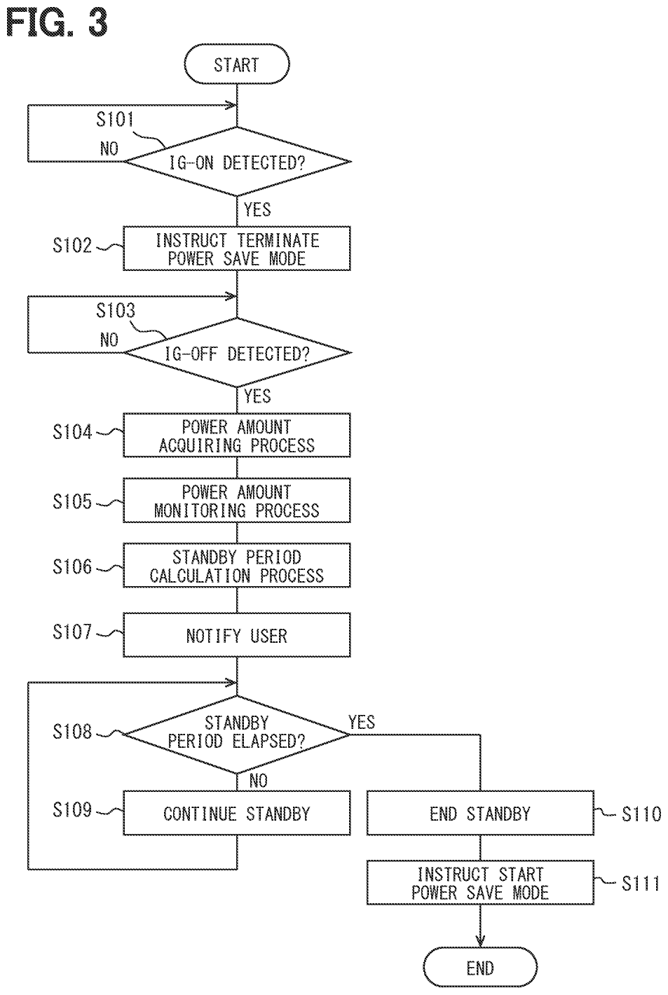

As illustrated in FIG. 3, the control unit 3 determines whether IG-ON is detected (S101).

When the user gets in the vehicle and turns on the ignition switch, IG-ON is detected (S101: YES), and thus the power source control unit 3d instructs the power source unit 4 to end the power save mode (S102). As a result, the power source unit 4 ends the power save mode and starts power supply to the wireless communication unit 6 and the GNSS reception unit 7. Thus, the on-board communication service can be executed by the wireless communication unit 6 and the GNSS receiving unit 7.

The process determines whether IG-OFF is detected (S103). When the user turns off the ignition switch, IG-OFF is determined to be detected (S103: YES). Then, a power amount acquiring process for acquiring the power consumption amount is executed (S104). Then, as described above, a power amount monitoring process for monitoring a decrease in the remaining battery power amount is executed (S105). The, a standby period calculation process for calculating the standby period is executed (S106). In response to the IG-OFF, the on-board communication service is terminated, and the execution of parked state communication service is started.

Then, the calculated standby period is notified to the user (S107). With this configuration, the user can check the standby period.

Then, the process determines whether the standby period has been elapsed (S108). When the standby period has not been elapsed (S108: NO), the standby is continued (S109). When the standby period has been elapsed (S108: YES), the standby is terminated (S110), and the power source unit 4 is instructed to start the power save mode (S111). The power source control process is performed by such an operation.

The above-described embodiment can provide the following effects.

The power amount acquiring unit 3a acquires the power consumption amount measured by the power amount measurement unit 8. The power amount monitoring unit 3b monitors a decrease in the remaining battery power amount based on a change in the power consumption amount in response to the IG switch being turned off. The standby period calculation unit 3c calculates the standby period based on the decreasing tendency of the remaining battery power amount. The power source control unit 3d continues the power supply from the power source unit 4 to the wireless communication unit 6 and the GNSS receiving unit 7 when the IG switch is turned off, and ends the power supply when the standby period is elapsed. Accordingly, the standby period can be properly set based on the decreasing tendency of the power consumption amount.

The standby period calculation unit 3c calculates the standby period on the basis of an estimated traveling limit reach period that is a period until a linear line indicating a decreasing tendency of the battery remaining power amount intersects with a predetermined threshold value. The power amount measurement unit 8 calculates the standby period based on the start limit reach period, which is a period until the straight line indicating the decreasing tendency of the battery voltage intersects with the start limit threshold. As a result, the standby period can be set in consideration of a sufficient margin for the start limit reach period.

Since the power amount measurement unit 8 is provided to the power source terminal 10a of the vehicle battery 10 and measures the power consumption amount, the detection accuracy of the power consumption can be improved.

The cloud server 2 may execute partial or entire portion of process set executed by the on-board communication device 1. In another example, the on-board communication device 1 may execute partial of the process set and the cloud server 2 may execute remaining of the process set, or vice versa.

### Second Embodiment

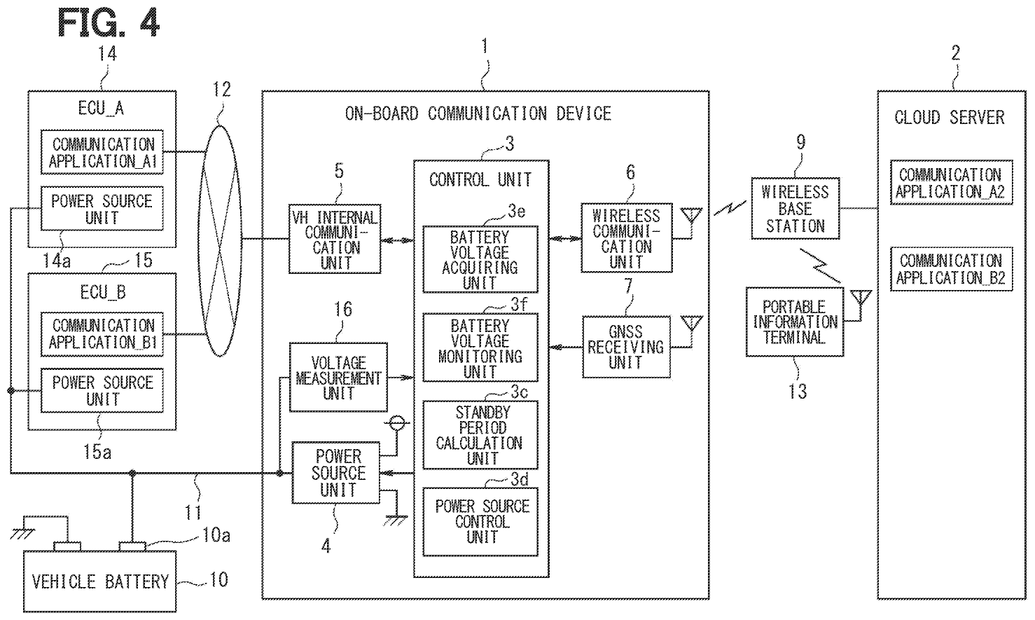

The second embodiment will be described with reference to FIG. 4 to FIG. 6. In the second embodiment, the standby period is calculated based on the decreasing tendency of the battery voltage as the remaining battery power amount.

When a current sensor is provided on the power source terminal 10a of the vehicle battery 10 as the power amount measurement unit 8, the current consumption of the vehicle battery 10 can be acquired by the current sensor. Thus, it is conceivable to calculate the battery remaining power amount based on the current consumption measured by the current sensor.

However, when the current consumption amount is measured by the current measurement unit, the product cost may be increased. Therefore, the battery voltage is measured by a voltage measurement unit, which has a low cost, and the remaining battery power amount is estimated based on the decreasing tendency of the battery voltage. In this case, when the voltage measurement unit is provided on the power source terminal 10a of the vehicle battery 10 may also cause an increase in cost. Thus, the voltage measurement unit is provided inside the on-board communication device 1.

As shown in FIG. 4, the on-board communication device 1 is provided with a voltage measurement unit 16. The voltage measurement unit 16 measures the battery voltage of the power supply line 11 in the on-board communication device 1. The control unit 3 includes a battery voltage acquiring unit 3e, a battery voltage monitoring unit 3f, a standby period calculation unit 3c, and a power source control unit 3d. The battery voltage is an example of the predetermined power amount, the battery voltage acquiring unit 3e is an example of the power amount acquiring unit, and the battery voltage monitoring unit 3f is an example of the power amount monitoring unit.

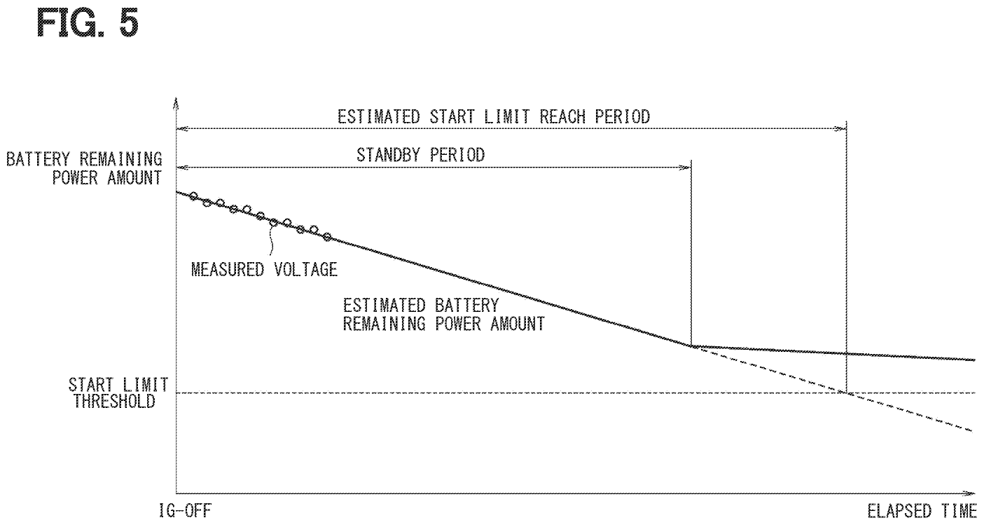

The start limit threshold shown in FIG. 5 is a battery power amount capable of supplying power necessary for driving the cell motor. When the battery voltage decreases to the start limit threshold, it is difficult to start the engine. Therefore, by accurately detecting the decreasing tendency of the battery voltage, it is possible to accurately set the standby period that can ensure the start of engine after elapse of the set standby period.

In the power save mode, the amount of current consumption per unit time in the entire on-board communication device 1 can be considered to be constant. Thus, the battery voltage can be considered to decrease linearly with the elapse of time. In this case, the battery voltage may temporarily fluctuate. The influence of temporary voltage fluctuation can be eliminated by detecting the battery voltage for a predetermined period sufficient to detect the decreasing tendency of the battery voltage.

When the user performs the IG-OFF, the decreasing tendency of the battery voltage is detected for a predetermined period from the IG-OFF. Then, a period until the straight line indicating the decreasing tendency of the battery voltage intersects with the start limit threshold, that is, a period until the battery voltage decreases to the start limit threshold is estimated as the start limit reach period. Then, the standby period in which a sufficient margin is set with respect to the estimated start limit reach period is calculated.

Only the operations of the control unit 3 different from those of the first embodiment will be described.

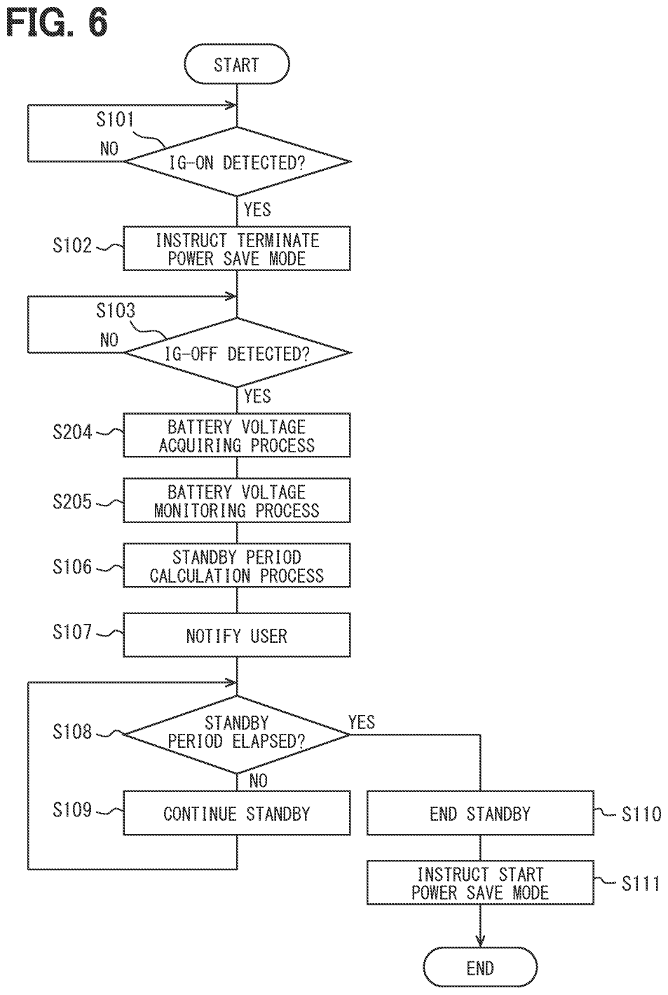

As shown in FIG. 6, when IG-OFF is detected (S103: YES), the control unit 3 executes a battery voltage acquiring process for acquiring the battery voltage from the voltage measurement unit 16 (S204). Then, a battery voltage monitoring process for monitoring the battery voltage is executed (S205). Then, the standby period calculation process for calculating the standby period as described above is executed (S106). The battery voltage acquiring process is an example of the power amount acquiring process, and the battery voltage monitoring process is an example of the power amount monitoring process.

The second embodiment can provide the following effects.

In the present embodiment, the voltage measurement unit 16 measures the battery voltage of power supply line 11 connected to the power source terminal 10a of the vehicle battery 10. Thus, it is possible to properly set the standby period even when detection of the remaining battery power amount based on the consumption current is difficult.

The voltage measurement unit 16 is provided in the on-board communication device 1. Thus, there is no need to additionally install the voltage measurement unit 16, and thus it is possible to reduce the cost.

The voltage measurement unit 16 may be arranged close to the power source terminal 10a of the vehicle battery 10 with respect to the power supply line 11.

The cloud server 2 may execute partial or entire portion of process set executed by the on-board communication device 1. In another example, the on-board communication device 1 and the cloud server 2 may execute the process set in cooperative manner.

### Third Embodiment

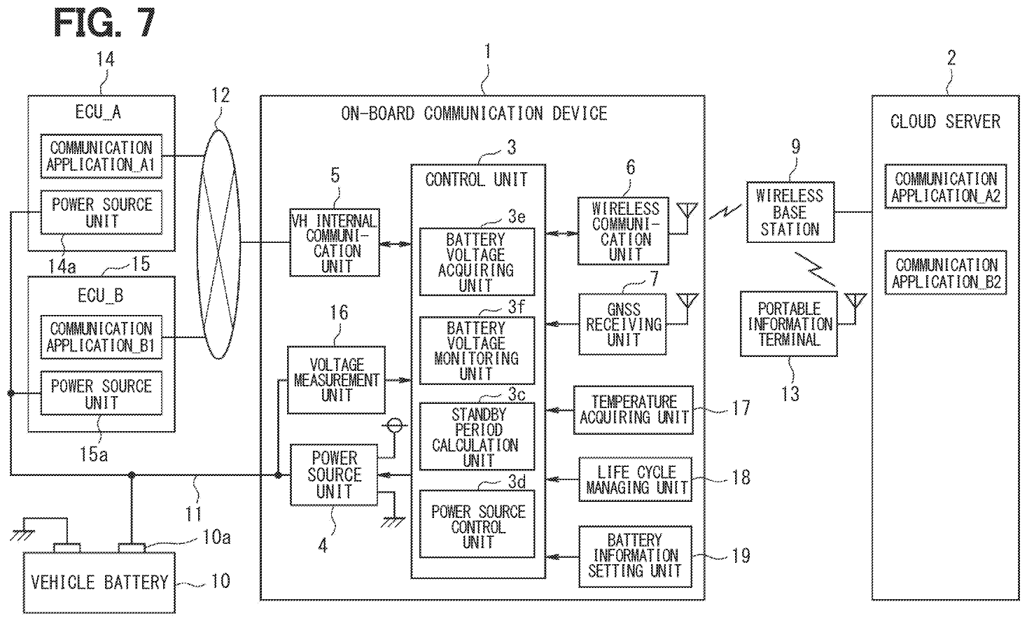

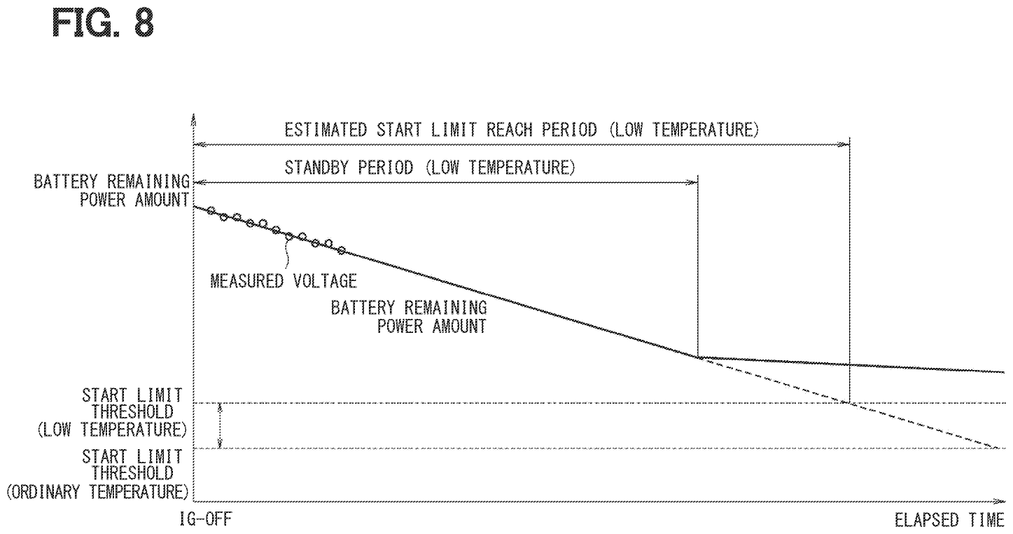

A third embodiment will be described with reference to FIG. 7 and FIG. 8. In the third embodiment, the start limit threshold is changed in accordance with information that may affect the remaining battery power amount. The information that may affect the remaining battery power amount is referred to as influence information. For example, the influence information may include difference in battery capacity depending on the vehicle grade, a difference in required power amount depending on the climate or temperature of different regions, a difference in power consumption depending on how the vehicle is used, or a difference in deterioration degree of the vehicle battery.

For example, since the internal resistance of the vehicle battery 10 increases with a temperature decrease, the battery voltage decreases with a temperature decrease. For this reason, if the standby period is calculated based on the start limit threshold corresponding to the ordinary temperature in a state where the actual temperature is lower than the ordinary temperature, it is predicted that the standby period set corresponding to the ordinary temperature is longer than the actual standby period to be set. Thus, start of the vehicle may become difficult. Therefore, the start limit threshold may be calculated based on the influence information, which is information indicating influences on the remaining power amount of the vehicle battery 10.

As illustrated in FIG. 7, the on-board communication device 1 includes a temperature acquiring unit 17, a life cycle managing unit 18, and a battery information setting unit 19. The temperature acquiring unit 17 acquires an ambient temperature from a temperature sensor (not shown). The life cycle managing unit 18 manages battery deterioration due to use of the battery for a long period. The battery information setting unit 19 sets a battery type or acquiring date and time as battery information. The temperature acquiring unit 17, the life cycle managing unit 18, and the battery information setting unit 19 are examples of an influence information acquiring unit.

The life cycle information of battery may be reflected as the battery information, or information on the replacement of the vehicle battery 10 may be reflected in the life cycle information. Battery replacement may be detected from the measurement result of the battery voltage and automatically reflected in the life cycle information.

The following will describe a case where the standby period is calculated based on the ambient temperature acquired by the temperature acquiring unit 17.

The temperature acquiring unit 17 acquires the ambient temperature measured by the temperature sensor in response to an instruction from the control unit 3, and sets the start limit threshold corresponding to the low temperature in addition to the start limit threshold corresponding to the ordinary temperature. In this case, the start limit threshold corresponding to the low temperature is set to be higher than the start limit threshold corresponding to the ordinary temperature.

When the ambient temperature is lower than the ordinary temperature at the time of IG-OFF, the control unit 3 uses the start limit threshold corresponding to the low temperature to set the standby period. Specifically, a period until the straight line indicating the decreasing tendency of the battery voltage intersects with the start limit threshold corresponding to the low temperature is estimated as the start limit reach period at low temperature. Then, the standby period at low temperature is set to have a sufficient margin with respect to the start limit reach period.

The performance deterioration due to the long-term use of the vehicle battery acquired by the life cycle managing unit 18 and the replacement time of the vehicle battery set by the battery information setting unit 19 are reflected in the standby period.

According to the present embodiment, since the start limit threshold is changed in accordance with the influence information indicating the information that influences the remaining battery power amount, the standby period can be properly set corresponding to the influence information.

Note that the start limit threshold is not limited to two level setting according to the temperature as described above. For example, three or more thresholds may be set according to the temperature, or the threshold may be set again in accordance with a change in the temperature after one threshold has been set.

The cloud server 2 may execute partial or entire portion of process set executed by the on-board communication device 1. In another example, the on-board communication device 1 and the cloud server 2 may execute the process set in cooperative manner.

### Fourth Embodiment

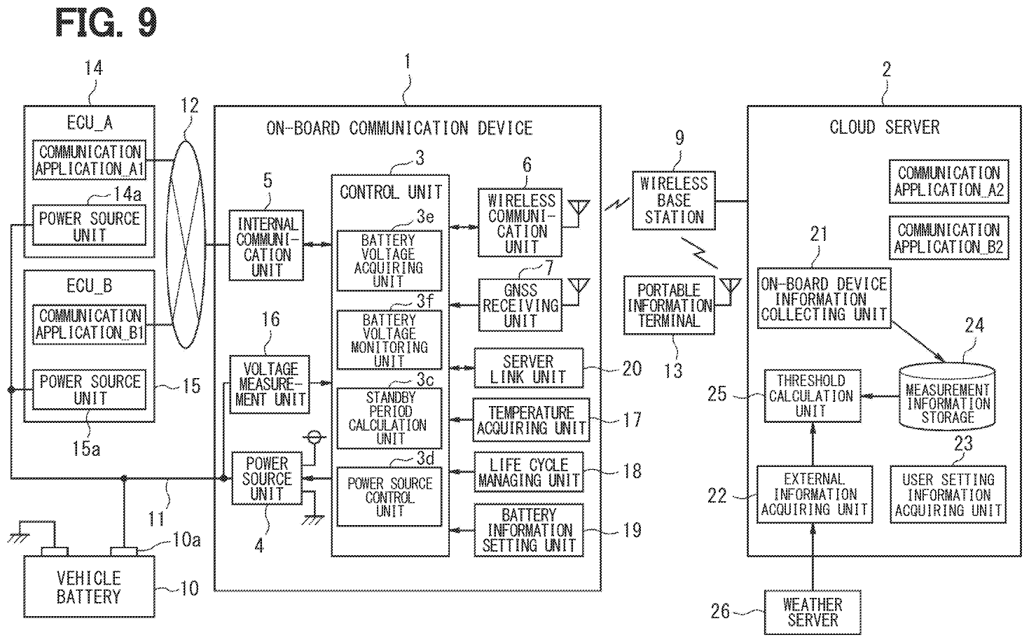

A fourth embodiment will be described with reference to FIG. 9. In the present embodiment, the cloud server 2 collects the above-described influence information and calculates the standby period.

As shown in FIG. 9, the on-board communication device 1 includes a server link unit 20. The cloud server 2 includes an on-board device information collecting unit 21, an external information acquiring unit 22, a user setting information acquiring unit 23, a measurement information storage 24, and a threshold calculation unit 25. These units are implemented by a computer program.

The on-board device information collecting unit 21 in the cloud server accumulates and stores various types of measurement information collected by the on-board communication device 1 in the measurement information storage 24 in cooperation with the server link unit 20 of the on-board communication device 1. The external information acquiring unit 22 acquires, from a weather server 26, weather information corresponding to a location of the on-board communication device 1. The user setting information acquiring unit 23 acquires a schedule of user from a user terminal such as a portable information terminal 13.

When IG-OFF is detected, the control unit 3 acquires, using the battery voltage acquiring unit 3e, the battery voltage from the power amount measurement unit 8. The control unit 3 further acquires predetermined influence information using an influence information acquiring unit, such as the temperature acquiring unit 17, and transmits the acquired influence information to the cloud server 2 via the wireless communication unit 6.

The on-board device information collecting unit 21 of the cloud server 2 accumulates and stores, in the measurement information storage 24, various types of measurement information acquired from a large number of on-board communication devices 1 mounted on vehicles nationwide as described above.

The threshold calculation unit 25 calculates the traveling limit threshold and the start limit threshold based on the big data accumulated and stored in the measurement information storage 24. The decreasing tendency of the remaining battery power amount acquired from the on-board communication device 1 is affected by the ambient temperature and other influence information. Thus, it is desirable to set the standby period with consideration of the decreasing tendency of remaining battery power amount measured by another on-board communication device 1.

With consideration of above circumstances, the cloud server 2 calculates the remaining battery power amount from big data including data acquired from other vehicles. That is, the cloud server 2 calculates the remaining battery power amount necessary for the next time start and next time travel based on the influence information, and the cloud server 2 calculates the standby period based on the forecast value of the temperature and the schedule of user. When the set standby period is long, it is assumed that the standby period is affected by a temperature change or the schedule of user. The predicted value of the temperature reflects the temperature data corresponding to the current location of the vehicle. The standby period is calculated in consideration of the predicted value of the temperature and the schedule of user, and the standby period is transmitted to the on-board communication device 1.

According to the present embodiment, the cloud server 2 calculates the standby period based on big data received from a large number of on-board communication devices 1 all over the country, and transmits the calculated standby period to the on-board communication device 1. By utilizing big data of a large number of vehicles in the cloud server 2, it is possible to omit a learning period and provide control corresponding to a place different from a place where a vehicle is usually used or a change due to a season.

The cloud server 2 may execute partial or entire portion of process set executed by the on-board communication device 1. In another example, the on-board communication device 1 and the cloud server 2 may execute the process set in cooperative manner.

### Other Embodiments

In the second to fourth embodiments, the voltage measurement unit 16 may be provided on the power source terminal 10a of the vehicle battery 10 instead of inside the on-board communication device.

In the fourth embodiment, the decreasing tendency of the remaining battery power amount calculated based on the big data and acquired by the cloud server 2 may be transmitted to the on-board communication device 1, and the on-board communication device 1 may calculate the standby period based on the received decreasing tendency of the remaining battery power amount.

Power supply from the power source units 14a, 15a to respective ECUs 14, 15 may be controlled by the power source control unit 3d in the parked state. That is, when the required operation continuation periods of the respective on-board devices from IG-OFF are different from one another, the power supply to the respective on-board devices is controlled in accordance with the operation continuation periods.

Although the present disclosure has been described in accordance with above embodiments, it is understood that the present disclosure is not limited to such embodiments or structures. The present disclosure also includes various modification examples or variations within the scope of equivalents. Furthermore, various combination and configuration, and other combination and configuration including one, more than one or less than one element may be made in the present disclosure.

The control unit and the method thereof described in the present disclosure may be implemented by a dedicated computer, which is configured by a processor and a memory programmed to execute one or multiple functions embodied by a computer program. Alternatively, the control unit and the method thereof described in the present disclosure may be implemented by a dedicated computer, which is configured by a processor and one or more dedicated hardware logic circuits. Alternatively, the control unit and the method thereof described in the present disclosure may be implemented by a combination of (i) a special purpose computer including a processor programmed to execute one or more functions by executing a computer program and a memory and (ii) a special purpose computer including a processor with one or more dedicated hardware logic circuits. The computer program may be stored in a computer-readable non-transitory tangible storage medium as instructions to be executed by a computer.

What is claimed is:

1. A control method of vehicle power source which controls a power source of a vehicle, the vehicle including: a wireless communication unit communicating with an external source; a power source unit supplying an electric power of a vehicle battery to the wireless communication unit in a stabilized manner; and a power amount measurement unit measuring a predetermined power amount that changes corresponding to a decrease in a battery remaining power amount of the vehicle battery,
the control method comprising processes of:
acquiring the predetermined power amount measured by the power amount measurement unit;
monitoring the decrease in battery remaining power amount based on the predetermined power amount in response to turning off of a main switch of the vehicle;
calculating a standby period based on a decreasing tendency of the battery remaining power amount;
continuing a power supply state from the power source unit to the wireless communication unit in response to turning off of the main switch; and
terminating the power supply state in response to elapse of the standby period.

2. The control method of vehicle power source according to claim 1, wherein
partial or entire of the processes are executed by an on-board communication device equipped to the vehicle.

3. The control method of vehicle power source according to claim 1, wherein
partial or entire of the processes are executed by a cloud server, which is communicable with the wireless communication unit.

4. The control method of vehicle power source according to claim 1, wherein
partial of the processes are executed by an on-board communication device equipped to the vehicle, and
remaining of the processes are executed by a cloud server, which is communicable with the wireless communication unit.

5. The control method of vehicle power source according to claim 1, wherein
the predetermined power amount is consumption power amount of the vehicle battery.

6. The control method of vehicle power source according to claim 1, wherein
the predetermined power amount is a battery voltage indicating a voltage of the vehicle battery.

7. The control method of vehicle power source according to claim 1, wherein
the calculating of standby period includes calculating the standby period based on an estimated limit reach period, and
the estimated limit reach period is a period until a straight line indicating the decreasing tendency of the battery remaining power amount intersects with a predetermined threshold.

8. The control method of vehicle power source according to claim 7, further comprising
acquiring, by an influence information acquiring unit, influence information that affects the battery remaining power amount,
wherein the predetermined threshold is set with reference to the influence information.

9. The control method of vehicle power source according to claim 1, wherein
the power amount measurement unit measures the battery remaining power amount at a power source terminal of the vehicle battery or at a location close to the power source terminal in a power supply line.

10. A computer-readable non-transitory storage medium storing a vehicle computer program to be executed by a processor of a vehicle, the vehicle including: a wireless communication unit communicating with an external source; a power source unit supplying an electric power of a vehicle battery to the wireless communication unit in a stabilized manner; a power amount measurement unit measuring a predetermined power amount that changes corresponding to a decrease in a battery remaining power amount of the vehicle battery; and a control unit including the processor,
the vehicle computer program comprising:
acquiring, by the control unit, the predetermined power amount measured by the power amount measurement unit;
monitoring, by the control unit, the decrease in battery remaining power amount based on the predetermined power amount in response to turning off of a main switch;
calculating, by the control unit, a standby period based on a decreasing tendency of the battery remaining power amount;
continuing, by the control unit, a power supply state from the power source unit to the wireless communication unit in response to turning off of the main switch of the vehicle; and
terminating, by the control unit, the power supply state in response to elapse of the standby period.
